(19) United States
(12) Patent Application Publication
(10) Pub. No.: US 2022/0265076 A1
(43) Pub. Date: Aug. 25, 2022

(54) Opening and closing device for curtains and system based on the same

(71) Applicant: Woan Technology (Shenzhen) Co. Ltd, Shenzhen, Guangdong (CN)

(72) Inventors: Wei Hou, Shenzhen, Guangdong (CN); Zhichen Li, Shenzhen, Guangdong (CN); Yang Pan, Shenzhen, Guangdong (CN); Guohui Liu, Shenzhen, Guangdong (CN); Chao Ma, Shenzhen, Guangdong (CN); Changhai Liao, Shenzhen, Guangdong (CN)

(21) Appl. No.: 17/628,181

(22) PCT Filed: Oct. 12, 2019
(86) PCT No.: PCT/CN2019/110846

§ 371 Date: Jan. 18, 2022

(51) Int. Cl. A47H 5/032; A47H 1/04

(52) U.S. Cl. CPC A47H 5/0325; A47H 1/04; A47H 13/04

(57) ABSTRACT

An opening and closing device for curtains and a system based on the same, mounted on a curtain track, comprises a main engine and a roller mechanism, The main engine comprises a shell with a cavity, a driving wheel mounted in the cavity and partially exposed the shell, a motor arranged in the cavity and controlling the driving wheel to rotate, a controller lied in the cavity and controlling the motor to start and stop, and a signal transceiver module coupled electrically with the controller and receiving starting and stopping signals of the motor; the driving wheel is used for driving the curtains to move along the curtain track; a roller mechanism is mounted on the shell, an end, far away from the shell, of the roller mechanism is hung on the curtain track and presses the driving wheel closely on the curtain track.

### FIELD OF THE INVENTION

The present invention relates to smart furniture technical field, more particularly, relates to an opening and closing device for curtains and a system based on the same.

### BACKGROUND OF THE INVENTION

In traditional technologies, curtains are mostly opened and closed by manual operation. This kind of curtains is troublesome in control, and the convenience of control is poor.

Smart controls for the curtains are the most important part in smart home field. In order to improve the convenience of controlling the curtains, electrical curtains that can be opened and closed through electric control have been launched in the market. However, for the existing electrical curtains, special curtain tracks and motors need to be installed on sites, the installments are complex and the cost is high.

### SUMMARY OF THE INVENTION

In order to overcome the deficiencies in the prior art, an object of the present invention is to provide an opening and closing device for curtains, which can resolve the deficiencies that the installments for the curtain tracks and the motors on site are complex and the cost is high.

The other object of the present invention is to provide a system of the opening, and closing device for the curtains, which controls the opening and the closing of the curtains.

The technical schemes adopted in the present invention are as follows:

The opening and closing device for the curtains, mounted on a curtain track, includes a main engine and a roller mechanism.

The main engine includes a shell with a cavity, a driving wheel mounted in the cavity and partially exposed the shell, a motor arranged in the cavity and controlling the driving wheel to rotate, a controller lied in the cavity and controlling the motor to start and stop, and a signal transceiver module coupled electrically to the controller and receiving starting and stopping signals of the motor. The driving wheel is used for driving the curtain to move along the curtain track.

The roller mechanism is mounted on the shell. An end, far away from the shell, of the roller mechanism is hung on the curtain track and presses the driving wheel closely on an outer wall for the curtain track.

Furtherly, the roller mechanism includes a base connected to the shell, an elastic assembly connected with the base, and a roller assembly arranged at a side, facing the curtain track, of the elastic assembly. The roller assembly is hung on the is curtain track. The elastic assembly includes a connecting rod and an elastic piece. One end of the connecting rod is connected with the roller assembly, the other end of the connecting rod is actively connected with the base. The elastic piece lies in the base and is sleeved on the connecting rod and used for pressing the driving wheel closely to the curtain track.

Furtherly, the base has a first chamber and a second chamber arranged at a side, far away from the roller assembly, of the first chamber and communicated with the first chamber, and a first through hole arranged at a side, close to the roller assembly, of the first chamber and communicated with the first chamber. The elastic piece is accommodated in the first chamber, the connecting rod actively passes through the first through hole, the first chamber and the second chamber.

Furtherly, the shell is concave with a mounting slot for mounting the base.

Furtherly, the mounting slot lies on the middle of the shell, the shell is provided with a groove communicated with the mounting slot so that the connecting rod can pass through the shell by the groove.

Furtherly, the shell includes a first part and a second part connecting with the first part, the first part and the second part are enclosed to form the cavity, the mounting slot, and the groove.

Furtherly, the base includes an outermost shell mounted in the mounting slot and a main body in the outermost shell, the main body includes a first portion and a second portion detachably connected with the first portion, the two are enclosed to form the first chamber, the second chamber, and the first through hole.

Furtherly, the shell is provided with two mounting slots respectively on opposite sides of the shell, each containing one of the base.

Furtherly, the base is fixedly or detachably mounted in the mounting slot.

Furtherly, the main engine also includes a motor sleeve for mounting the motor, the motor sleeve is fixed in the cavity, the motor sleeve is provided with a first is limited surface for preventing the motor from rotating relative the motor sleeve, the motor is provided with a second limited surface cooperating with the first limited surface.

Furtherly, the main engine also includes an anti-skid sleeve disposed an outside of the driving wheel to increase friction.

Furtherly, the opening and closing device for the curtain also includes a battery mounted in the shell and used for powering the motor, the controller, and the signal transceiver module.

Furtherly, the opening and closing device for the curtain also includes a solar panel for charging the battery, coupled electrically to the battery through the controller.

Furtherly, the roller assembly includes a bracket and two wheels mounted on the bracket and rolling connection to the curtain track. The bracket includes a transverse plate for connecting the connecting rod, two vertical plates protruding respectively from opposite ends of the transverse plate, the opposite inner walls of the two vertical plates are respectively provided with one of the two wheels.

Furtherly, the connecting rod includes a rod body for the elastic piece to sleeve and a hook located at one end, towards the roller assembly, of the rod body, the roller assembly also includes a protrusion arranged at a surface of the transverse plate facing the connecting rod, the protrusion is provided with a second through hole fitting with the hook, the roller assembly is detachably connected with the connecting rod through the cooperation of the hook and the second through hole.

Furtherly, the bracket is elastic.

Furtherly, the roller assembly includes a fixed shaft and two wheels respectively mounted on both ends of the fixed shaft, the wheels are rolling connection to the curtain track, the fixed shaft runs through an end, facing to the curtain track, of the connecting rod.

Furtherly, the fixed shaft includes a shaft rod passing through the connecting rod and a convex ring located at both ends of the shaft rod for limiting to is the wheels.

The system based on the above opening and closing device for the curtains includes a remote control terminal for controlling the start or the stop of the opening and closing device for the curtain.

Compared with the prior art, the advantages of the present invention are as follows: The opening and closing device for the curtains includes the main engine and the roller mechanism, the main engine includes a shell, a driving wheel, a motor, a controller, and a signal transceiver module. The roller mechanism is hung on the curtain track and compresses the driving wheel on the outer wall for the curtain track. The motor works to drive the driving wheel to roll on the curtain track, the driving wheel brings the opening and closing device for the curtains to move along the curtain track. When the opening and closing device for the curtains is mounted, the roller mechanism is directly hung on the curtain track. It does not need to use auxiliary tools for installation, the operation is simple and the cost is reduced.

### BRIEF DESCRIPTION OF THE DRAWINGS

In order to more clearly illustrate the technical schemes in the embodiments in the present invention, the drawings needed in the embodiments or the prior technical description are briefly introduced below. Obviously, the drawings described below are only some embodiments in the present invention, and for those skilled in the art, additional drawings may be obtained according to the drawings below without creative work.

FIG. 1 is an assembly view of the opening and closing device for the curtains and the curtain track provided in an embodiment according to the present invention.

FIG. 2 is a perspective view of the opening and closing device for the curtains shown in FIG. 1.

FIG. 3 is a perspective view of the shell of the opening and closing is device for the curtains shown in FIG. 2.

FIG. 4 is a decomposition view of the shell of the opening and closing device for the curtains shown in FIG. 3.

FIG. 5 is a decomposition view of the second shell body, the driving wheel, the anti-skid sleeve, the motor, and the motor sleeve of the opening and closing device for the curtains provided in an embodiment according to the present invention.

FIG. 6 is a perspective view of the roller mechanism of the opening and closing device for the curtains shown in FIG. 2.

FIG. 7 is a decomposition view of the roller mechanism of the opening and closing device for the curtains shown in FIG. 6.

FIG. 8 is a perspective view for the curtains track of the opening and closing device for the curtains shown in FIG. 1.

FIG. 9 is a decomposition view of the second shell body, the controller, the solar panel, the battery, the signal transceiver module and the charging module of the opening and closing device for the curtains provided in an embodiment according to the present invention.

FIG. 10 is an assembly view of the opening and closing device for the curtain and the curtain track provided in an embodiment according to the present invention.

FIG. 11 is a decomposition view of the roller mechanism of the opening and closing device for the curtains shown in FIG. 10.

FIG. 12 is a perspective view for the curtain track of the opening and closing device for the curtains shown in FIG. 10.

### DETAILED DESCRIPTION OF ILLUSTRATED EMBODIMENTS

In order to make the invention purpose, the technical scheme and the technical effect more clearly be understood, the invention is Furtherly explained in combination with the concrete embodiment below. It should be understood that the specific embodiments described herein are only used to interpret the invention and are not used to limit the invention.

Embodiments of the present invention are described in detail below, and examples of the embodiments are shown in the attached drawings, in which the same or similar labels represent the same or similar elements or elements with the same or similar function. The embodiments described below by reference to the attached drawings are exemplary and are intended to explain embodiments of the present invention and cannot be understood as limits in the present invention.

In the description of the embodiments of the present invention, it should be understood that the directional indications involved in the embodiments, such as the “upper”, “lower”, “left”, “right”, “front”, “rear”, “internal” and “external”, indicating orientation or location relationship, are based on the orientation or position relationship shown in the figures. These directional indications are only for describing the embodiments in the present invention and simplifying the description, rather than indicating or implying that the device or the element must be constructed and operated in a specified azimuth, which cannot be understood as a limitation of the present invention.

Furtherly, the terms “first” , and “second” are used only for description purposes, and cannot be understood as indicating or implying relative importance or implicitly indicating the number of technical features indicated. Thus, features defining “first” and “second” may expressly or implicitly include one or more of the features. In the description of the embodiments of the present invention, the “plurality of ” means two or more unless otherwise specifically limits.

In the embodiments of the invention, unless otherwise clearly specified and defined, the terms, “installed”, “connected”, “or” fixed” should be generally understood, for example, a fixed connection, or a removable connection, a mechanical connection or an electrical connection, or an directly connection or an indirectly connection through an intermediate media, or a connection within two elements or the interaction of two elements. For those of ordinary skilled in the art, is the specific meaning of the above terms in the embodiment of the present invention may be understood under specific circumstances.

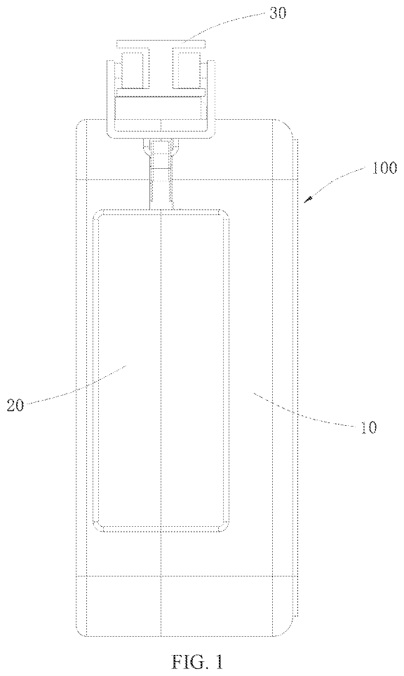

Please referring to FIG. 1 to FIG. 9, the system for opening and closing the curtains in embodiment according to the present invention, includes an opening and closing device 100 for curtains and a remote control terminal for controlling the start or the stop of the opening and closing device 100 for the curtains. The opening and closing device 100 for the curtains includes a main engine 10 and a roller mechanism 20. The main engine 10 includes a shell 12 with a cavity 11, at least a driving wheel 13 mounted in the cavity 11 and partially exposed the shell 12, a motor 14 arranged in the cavity 11 and controlling the driving wheel 13 to rotate, a controller 15 lied in the cavity 11 and controlling the motor 14 to start and stop, and a signal transceiver module 16 coupled electrically to the controller 15 and receiving starting and stopping signals of the motor 14. The driving wheel 13 is used for driving the curtains to move along the curtain track 30. The roller mechanism 20 is mounted on the shell 12. An end, far away from the shell 12, of the roller mechanism 20 is hung on the curtain track 30 and presses the driving wheel 13 closely on an outer wall for the curtain track 30.

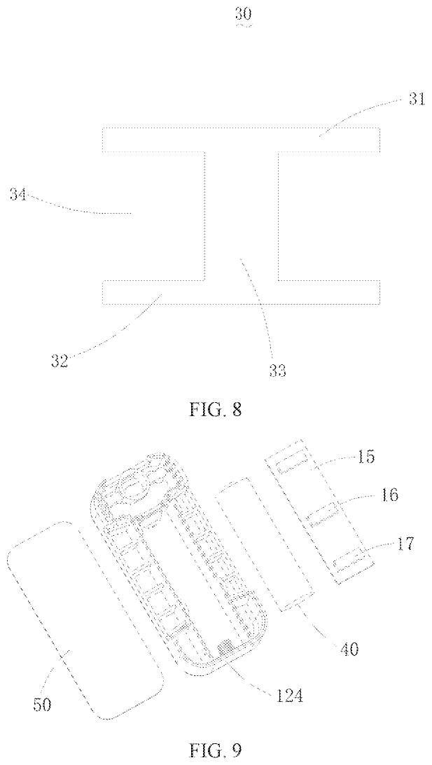

In the embodiment, referring to FIG. 8, the curtain track 30 includes a top plate 31, a bottom plate 32, and a connecting plate 33 connecting perpendicularly with the top plate 31 and the bottom plate 32, and the three enclosed to form two sliding grooves 34 with opposite opening. When the opening and closing device 100 for the curtains is mounted, the roller mechanism 20 is directly hung in the two sliding grooves 34 for the curtain track 30, thus the whole opening and closing device 100 for the curtains is hung on the curtain track 30, and the driving wheel 13 of the main engine 10 is pressed closely on the outer wall, far away from the top plate 21, of the bottom plate 32. When the signal transceiver module 16 receives a work signal from the remote control terminal, the controller 15 controls the motor 14 to rotate forwardly, reversely or stop rotating. After the motor 14 rotates, it drives the driving wheel 13 to move on the bottom plate 32, and drives the opening and closing device 100 for the curtains to move together along the curtain track, thereby opening and closing the curtains.

Because the opening and closing device 100 for the curtains is directly hung on the curtain track 30, it does not need to use auxiliary tools for installation, the operation is simple and the cost is reduced. Moreover, when the remote control terminal fails or the user is inconvenient to use it, the user can manually control the movement of the opening and closing device 100 for the curtains, so as to open and close the curtains, which is more convenient for the user.

Specifically, in the embodiment, the signal transceiver module 16 is mounted on the controller 15, and the controller 15 is provided with a charging module 17.

It should be understood that the remote control terminal may be a remote control specifically for controlling the opening and closing device 100 for the curtains, or a smart electronic device such as a mobile phone.

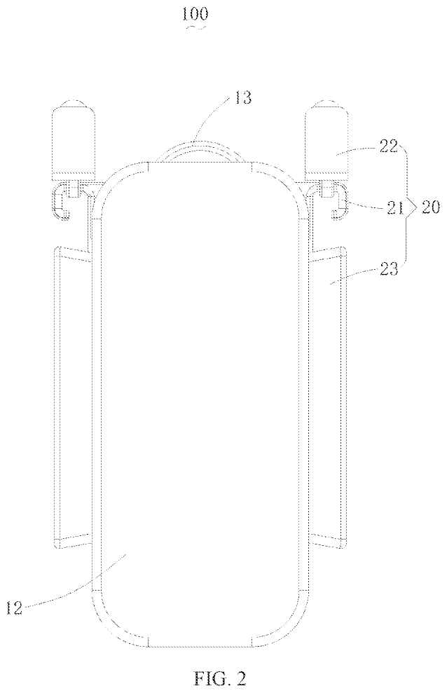

Referring to FIG. 2 and FIG. 7, as an improved scheme of the embodiment, the roller mechanism 20 includes an elastic assembly 21, a roller assembly 22, and a base 23. The base 23 is connected with the shell 12. The roller assembly 22 is hung on the curtain track 30. The elastic assembly 21 includes a connecting rod 211 and an elastic piece 212. One end of the connecting rod 211 is connected with the roller assembly 22, the other end of the connecting rod 211 is actively connected with the base 23. The elastic piece 212 lies in the base 23 and is sleeved on the connecting rod 211 and used for pressing the driving wheel 13 closely on the curtain track 30.

Preferably, the elastic piece 212 is a spring and sleeved on the connecting rod 211. After the spring is compressed, the connecting rod 211 obtains a force pushing the base 23, the base 12 is moved towards the curtain track 30 under the function of the force and the shell 12 is drove to move together, so that the driving wheel 13 is pressed closely on the bottom plate 32 for the curtain track 30.

Referring to FIG. 2 and FIG. 7, as an improved scheme of the is embodiment, the base 23 has a first chamber 231 and a second chamber 232 arranged at a side, far away from the roller assembly 22, of the first chamber 231 and communicated with the first chamber 231, and a first through hole 233 arranged at a side, close to the roller assembly 22, of the first chamber 231 and communicated with the first chamber 231. The elastic piece 212 is received in the first chamber 231, the connecting rod 211 actively passes through the first through hole 233, the first chamber 231 and the second chamber 232.

In the embodiment, the first chamber 231, the second chamber 232 and the first through hole 233 are arranged in the base 23, and the second chamber 232 and the first through hole 233 are respectively located opposite sides of the first chamber 231 and both communicated with the first chamber 231. The elastic piece 212 is accommodated in the first chamber 231, and the connecting rod 211 is provided with a stopping part 234. One end of the elastic piece 212 is against an inner wall, close to the roller assemble 22, of the first chamber 231 the other end of the elastic piece 212 is against the stopping part 234.

Thus, when installing the opening and closing device 100 for the curtains, the user pulls the base 23 towards a direction far away the curtain track 30, due to the connection of the connecting rod 211 and the roller assembly 22, the base 23 will be moved relative to the connecting rod 211 in the direction far away the curtain track 30 and the elastic piece 212 is compressed. After the user releases the base 23, the elastic piece 212 pushes the base 23 towards the curtain track 30 under the action of its own elastic force, the base 23 drives the shell 12 to move together, thereby pressing the driving wheel 12 closely on the curtain track 30, which promises that the opening and closing device 100 can operate smoothly. Moreover, due to the spring has a certain amount of expansion, the opening and closing device 100 for the curtains can adapt to the curtain track 30 with different thicknesses, improving the practicability of the opening and closing device 100.

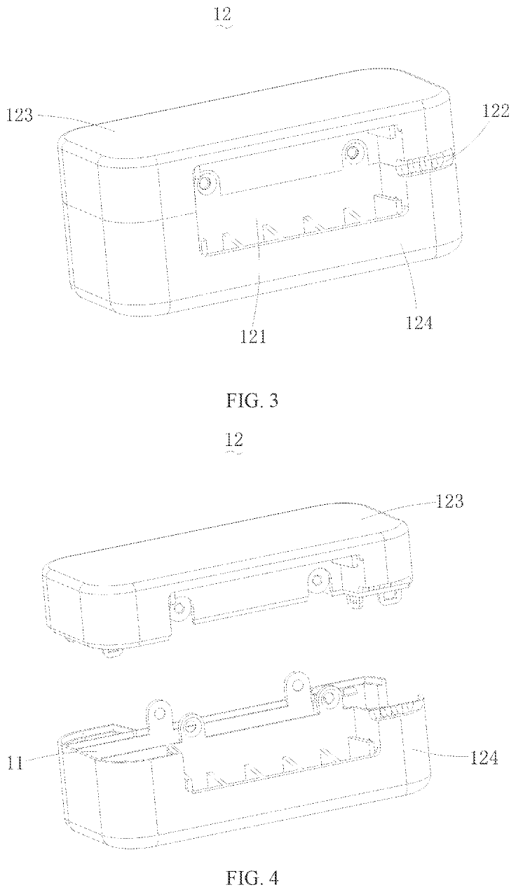

Referring to FIG. 3, as an improved scheme of the embodiment, the shell 12 is concave with at least one mounting slot 121 for mounting the base 23. The base is 23 is mounted in the mounting slot 121, which improves the compactness of the overall structure of the opening and closing device 100 for the curtains.

Referring to FIG. 3, as an improved scheme of the embodiment, the mounting slot 121 lies on the middle of the shell 12, the shell 12 is provided with a groove 122 communicated with the mounting slot 121 so that the connecting rod 211 can pass through the shell by the groove 122. With these structures, when the shell 12 is moved relative to the connecting rod 211, the connecting rod 211 has a guiding effect on the shell 12.

Referring to FIG. 3 and FIG. 4 as an improved scheme of the embodiment, the shell 12 includes a first part 123 and a second part 124 connecting to the first part 123, the two are enclosed to form the cavity 11, the mounting slot 121 and the groove 122. In the embodiment, with these structures, the opening and closing device 100 for the curtains is convenient to assemble, and the first part 123 and the second part 124 are fixedly connected via a screw and a bolt, which promises, the structure of the opening and closing device 100 for the curtains is reliable.

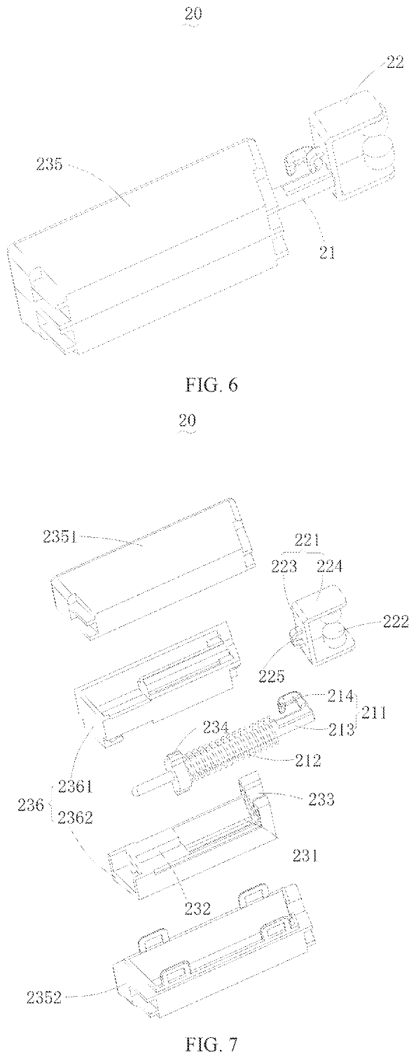

Referring to FIG. 6 and FIG. 7, as an improved scheme of the embodiment, the base 23 includes an outermost shell 235 mounted in the mounting slot 121 and a main body 236 in the outermost shell 235. The main body 236 includes a first portion 2361 and a second portion 2362 detachably connected with the first portion 2361, the two are enclosed to form the first chamber 231, the second chamber 232 and the first through hole 233.

With these structures, it is convenient to assemble the base 23 and the elastic piece 21, moreover, the outermost shell 235 can protect the main body 236, which prolongs the lifetime of the opening and closing device 100 for the curtains.

Specifically, in the embodiment, the outermost shell 235 includes a first accommodating portion 2351 for the first portion 2361, and a second accommodating portion 2352 for the second portion 2362.

As an improved scheme of the embodiment, the shell 12 is provided with two mounting slots 121, respectively on opposite sides of the shell 12, each containing one of the base 23. This structures can promise the driving wheel 12 is pressed closely on the curtain track 30.

It should be understood that, the number of the base 23 is not limited to two, for example, it may be one or multiple.

Referring to FIG. 1, FIG. 6 and FIG. 7, as an improved scheme of the embodiment, the roller assembly 22 includes a bracket 221 and two wheels 222 mounted on the bracket 221 and rolling connection to the curtain track 30. The bracket 221 is elastic and includes a transverse plate 223 for connecting the connecting rod 211, two vertical plates 224 protruding respectively from opposite ends of the transverse plate 223, the opposite inner walls of the two vertical plates 224 are respectively provided with one of the two wheels 222.

When installing the roller assembly 22 on the curtain track 30, the two vertical plates 224 can be pushed respectively outward at a certain angle, so that the distance between the two wheels 222 is greater than the width of the bottom plate 32 so that the wheels 222 can be directly held into the curtain track 30, which facilitates the installation of the roller assembly 22 and adapts the roller assembly 22 to the curtain track 30 with different widths, and improves the practicability of the roller assembly 22.

Referring to FIG. 6 and FIG. 7, as an improved scheme of the embodiment, the connecting rod 211 includes a rod body 213 for the elastic piece 212 to sleeve and a hook 214 located at one end, toward the roller assembly 22, of the rod body 213. The roller assembly 22 also includes a protrusion 225 arranged at a surface of the transverse plate 223 facing to the connecting rod 211. The protrusion 225 is provided with a second through hole fitting with the hook 214, the roller assembly 22 is detachably connected with the connecting rod 211 through the cooperation of the hook 214 and the second through hole.

With these structures, the connecting method of the connecting rod 211 and the roller assembly 22 is simple, the assembly is convenient, moreover, the friction between the roller assembly 22 and the curtain track 30 can be reduced by the is wheels 222 for facilitating the opening and closing device 100 to move along the curtain track 30. Moreover, when selecting the appropriate roller mechanism 20 according to the width dimension for the curtain track 30, it may be just replaced the roller assembly 22.

Specifically, in the embodiment, the base 23 may be detachable in the mounting slot 121 so that the user may choose to replace the whole roller mechanism 20 or to replace only the roller assembly 22.

It should be understood that the base 23 is not limited in detachably mounted in the mounting slot 121, for example, it may be fixed in the mounting slot 121.

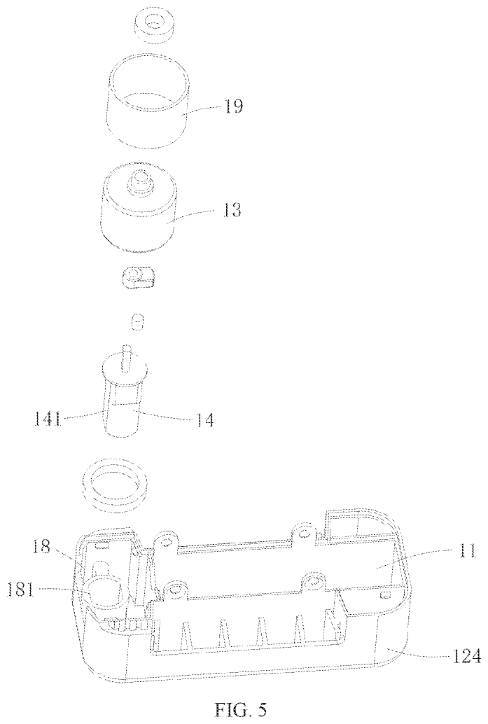

Referring to FIG. 5, as an improved scheme of the embodiment, the main engine 10 also includes a motor sleeve 18 for mounting the motor 14, the motor sleeve 18 is fixed in the cavity 11, the motor sleeve 18 is provided with a first limited surface 181 for preventing the motor 14 from rotating relative the motor sleeve 18, the motor 14 is provided with a second limited surface 141 cooperating with the first limited surface 181.

The first limited surface 181 and the second limited surface 141 are both planar. Through the cooperation of the first limit surface 181 and the second limit surface 141, the rotation of the motor 14 relative to the motor sleeve 18 can be prevented and the stability of the motor 14 can be improved. Moreover, the structures of the first limit surface 181 and the second limit surface 141 is simple and convenient for production.

It should be understood that the limitation between the motor 14 and the motor sleeve 18 is not limited to the above planar, for example, the limit can be achieved by fixed connection.

Referring to FIG. 5, as an improved scheme of the embodiment, the main engine 10 also includes an anti-skid sleeve 19 disposed an outside of the driving wheel 13 to increase friction. With the anti-skid sleeve 19, the friction between the driving wheel 13 and the curtain track 30 is increased, the sliding phenomenon of the is driving wheel 13 can be prevented, and the reliability of the opening and closing device 100 is improved.

Referring to FIG. 9, as an improved scheme of the embodiment, the opening and closing device 100 for the curtains also includes a battery 40 mounted in the shell 12 and used for powering the motor 14, the controller 15 and the signal transceiver module 16. The battery 40 is preferably a rechargeable battery, so that the opening and closing device 100 has its own power supply and requires no longer coupled to the external power supply for user convenience.

Referring to FIG. 9, as an improved scheme of the embodiment, the opening and closing device 100 for the curtains also includes a solar panel 50 for charging the battery 40, electrically coupled to the battery 40 through the controller 15. The solar panel 50 can convert solar energy into electric energy and store it, and then charge the battery 40 through the charging module 17. In this way, the user does not need to replace the battery 40, which is more convenient.

The process of the assemble and disassemble of the opening and closing device 100 for the curtains are as follows:

During assembly, selecting the two roller assemblies 22 with suitable specification according to the size for the curtain track 30, and mounting them on the connecting rod 211 through the cooperation between the hook 214 and the protrusion 225, then using the elasticity of the bracket 221, pushing the two vertical plates 220 outward until the wheels 222 can be directly held into the curtain track 30.

During disassembly, breaking two plates 224 of one bracket 221 to separate the roller assemblies 22 from the curtain track 30.

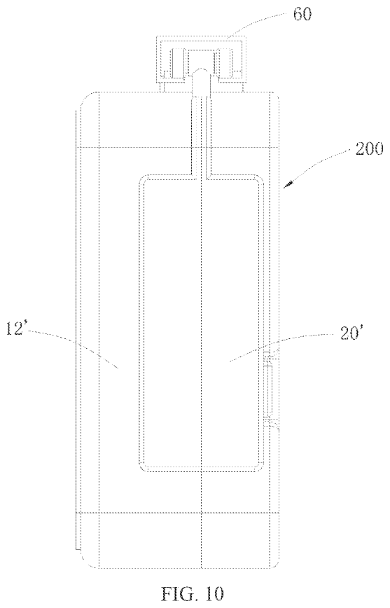

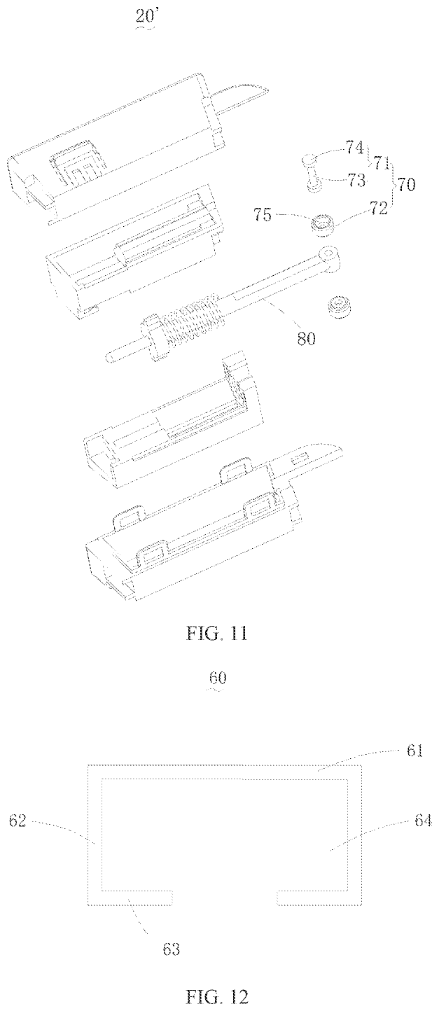

Please referring to FIG. 10 to FIG. 12, the main difference between the opening and closing device 100 for the curtains shown in FIG. 10 to FIG. 12 with those in the above embodiments is the curtain track, which resulting in the different structure of the roller mechanism 20′. Specifically, the curtain track 60 shown in FIG. 10 and FIG. 12 includes a top plate 61, two side plates 62 respectively extending from two sides of the top plate 61, and two bottom plates 63 extending from the ends, is far away from the top plate 61, of the two side plates 62. There is a certain spacing between the two bottom plates 63. The top plate 61, the side plates 62 and the bottom plates 63 are enclosed to form a smooth groove 64.

Referring to FIG. 11, the roller assembly 70 includes a fixed shaft 71 and two wheels 72. The fixed shaft 71 runs through an end, facing to the curtain track 60, of the connecting rod 80. Both ends of the fixed shaft 71 are respectively provided with one of the wheels 72, which is located in the smooth groove 64 and can be rolled on the bottom plate 63. The fixed shaft 71 includes a shaft rod 73 passing through the connecting rod 80 and a convex ring 74 located at both ends of the shaft rod 73 for limiting to the wheels 72. Two opposite side walls of the two wheels 72 are respectively provided with a recess 75 for accommodating the convex ring 74. The friction between the roller assembly 70 and the curtain track 60 can be reduced by the wheels 72 for facilitate to the opening and closing device 100 to move along the curtain track 60.

The process of the assemble and disassemble of the opening and closing device 100 for the curtains are as follows:

During assembly, selecting the two roller mechanisms 20′ with suitable specification according to the size for the curtain track 60, and mounting one of the two roller mechanisms 20′ to a side of the shell 12′, then rotating it to a certain angler so as to the fixed shaft 71 of the roller assembly 70 parallels to the curtain track 60, then inserting the wheels 72 into the curtain track 60 through the spacing between the two bottom plates 63, then rotating it by 90° and pull it down horizontally and remain motionless. The wheels 72 on the other roller mechanism 20′ is inserted into the curtain track 60 in the same way, then rotating it by 90° and mounting to the other side of the shell 12′ and the shell is installed.

Or, the two roller mechanisms 20′ may be mounted in the curtain track 60 respectively, then the roller mechanisms 20′ are mounted respectively on the shell 12′ from the two side for the curtain track 60.

During disassembly, it just needs to disassemble the roller mechanisms 20′ from the shell 12′, rotating the roller mechanisms 20′ by 90°, the roller mechanisms 20′ can be separated from the curtain track 60.

The above are only better embodiments of the invention and are not used to limit the invention, and any modifications, equivalent replacements, and improvements made within the spirit and principles of the invention shall be included within the protection of the invention.

What is claimed is:

1. An opening and closing device for curtains, mounted on a curtain track for controlling said curtains to open and close, wherein comprising:
a main engine, comprising a shell with a cavity, a driving wheel mounted in said cavity and partially exposed said shell, a motor arranged in said cavity and controlling said driving wheel to rotate, a controller lied in said cavity and controlling said motor to start and stop, and a signal transceiver module coupled electrically with said controller and receiving starting and stopping signals of said motor; said driving wheel is used for driving said curtains to move along, said curtain track;
a roller mechanism, mounted on said shell; an end, far away from said shell, of said roller mechanism is hung on said curtain track and presses said driving wheel closely on said curtain track.

2-20. (canceled)

21. The opening and closing device for said curtains according to claim 1, wherein said roller mechanism comprises at least one base connected to said shell and a roller assembly facing a side of said curtain track; said base is fixedly or detachably mounted on said shell.

22. The opening and closing device for said curtains according to claim 21, wherein said shell is concave with mounting slots for mounting said base, said base is fixedly or detachably mounted in said mounting slot.

23. The opening and closing device for said curtains according to claim 22, wherein the number of said mounting slots is two, respectively arranged on opposite side surfaces of said shell; said mounting slots and said driving wheel are located on adjacent side surfaces of said shell respectively, each of mounting slots contains one of said base.

24. The opening and closing device for said curtains according to claim 21, wherein said roller mechanism also comprises an elastic assembly connected with said base, said roller assembly is arranged on said elastic assembly.

25. The opening and closing device for said curtains according to claim 24, said elastic assembly includes a connecting rod and an elastic piece, one end of said connecting rod is connected with said roller assembly, the other end of said connecting rod is actively connected with said base, said elastic piece lies in said base and is used for pressing said driving wheel closely to said curtain track.

26. The opening and closing device for said curtains according to claim 25, wherein said elastic piece is sleeved on said connecting rod.

27. The opening and closing device for said curtains according to claim 26, said connecting rod is provided with a stopping part; one end of said elastic piece is against an inner side, close to said roller assemble, of said first chamber, the other end of said elastic piece is against said stopping part.

28. The opening and closing device for said curtains according to claim 25, wherein said base has a first chamber and a second chamber arranged at a side, far away from said roller assembly, of said first chamber and communicated with said first chamber, and a first through hole arranged at a side, close to said roller assembly, of said first chamber and communicated with said first chamber; said elastic piece is accommodated in said first chamber, said connecting rod actively passes through said first through hole, said first chamber, and said second chamber.

29. The opening and closing device for said curtains according to claim 28, wherein said base includes an outermost shell mounted in said mounting slot and a main body in said outermost shell, said main body includes a first portion and a second portion detachably connected with said first portion, said first portion and said second portion are enclosed to form said first chamber, said second chamber and said first through hole.

30. The opening and closing device for said curtains according to claim 25, wherein said roller assembly include a bracket and two wheels mounted on said bracket and rolling connection to said curtain track; said bracket includes a transverse plate and two vertical plates protruding from opposite ends of said transverse plate, opposite inner walls of said vertical plates are respectively provided with one of said two wheels.

31. The opening and closing device for said curtains according to claim 30, wherein said connecting rod is connecting with said transverse plate.

32. The opening and closing device for said curtains according to claim 31, wherein said connecting rod includes a rod body for said elastic piece to sleeve and a hook located at one end of said rod body toward said roller assembly, said roller assembly also includes a protrusion arranged at a side surface of said transverse plate facing said connecting rod, said protrusion is provided with a second through hole and fitting with said hook, said roller assembly is detachably connected with said connecting rod by the cooperation of the hook and the second through hole.

33. The opening and closing device for said curtains according to claim 25, wherein said roller assembly includes a fixed shaft and two wheels respectively mounted on both ends of said fixed shaft, said two wheels are rolling connection with said curtain track, said fixed shaft runs through an end, facing said curtain track, of said connecting rod.

34. The opening and closing device for said curtains according to claim 33, wherein said fixed shaft includes a shaft rod passing through said connecting rod and a convex ring located at both ends of said shaft rod for limiting to said wheels.

35. The opening and closing device for said curtains according to claim 34, wherein two opposite side walls of said two wheels are respectively provided with a recess for accommodating said convex ring.

36. The opening and closing device for said curtains according to claim 1, wherein said main engine also includes a motor sleeve for mounting said motor, said motor sleeve is fixed in said cavity, said motor sleeve is provided with a first limited surface for preventing said motor from rotating relative said motor sleeve, said motor is provided with a second limited surface cooperating with said first limited surface.

37. The opening and closing device for said curtains according to claim 1, wherein said main engine also includes an anti-skid sleeve disposed an outside of said driving wheel to increase friction.

38. The opening and closing device for said curtains according to claim 1, wherein also comprising a solar panel for charging said battery, coupled electrically to said battery through said controller.

39. The system based on said opening and closing device for said curtains according to claim 1, wherein comprising said opening and closing device of said curtains and a remote control terminal for controlling said start or said stop of said opening and closing device of said curtains;
after said signal transceiver module receives a signal from said remote control terminal, said controller controls said motor to rotate forwardly, reversely and stop rotating; said motor rotates to drive said driving wheel to move along said curtain track together with said curtains, and drive said opening and closing device for said curtains to move, so as to achieve the opening and the closing of said curtains.
